(19) United States
(12) Patent Application Publication
(10) Pub. No.: US 2012/0255453 A1
(43) Pub. Date: Oct. 11, 2012

(54) METHOD FOR PRODUCING A COMPONENT THAT CAN BE ACTIVATED TO EMIT LIGHT

(75) Inventor: Michael Finke, Elztal-Auerbach (DE)

(73) Assignee: FRANZ BINDER GMBH & CO. ELEKTRISCHE BAUELEMENT KG, Neckarsulm (DE)

(21) Appl. No.: 13/516,934

(22) PCT Filed: Dec. 9, 2010
(86) PCT No.: PCT/DE2010/001436

§ 371 Date: Jun. 18, 2012

(30) Foreign Application Priority Data
Dec. 18, 2009 (DE) 10 2009 059 779.4
Jan. 26, 2010 (DE) 10 2010 005 865.3

(51) Int. Cl. B41F 33/00

(52) U.S. Cl. 101/483

(57) ABSTRACT

A process to manufacture a component that can be activated to emit light whereby the light emission is done by electroluminescence (EL) includes the following process steps:
Providing and producing a carrier, essentially in the form of a component and its mechanical and electrical interfaces;
Printing of the carrier with functional layers of EL lighting, whereby at least one functional layer, namely the light-emitting layer or layers—in whole or at least in part—is/are generated with the tampon printing process and whereby the electrical interfaces are integrated into the print;
Generating a transparent or translucent cover for electrical and mechanical encapsulation.

### CROSS REFERENCE TO RELATED APPLICATIONS

This application is a national stage application, filed under 35 U.S.C. §371, of International Application No. PCT/DE2010/001436, filed Dec. 9, 2010, which claims priority to German Application Nos. 10 2009 059 779.4, filed Dec. 18, 2009 and 10 2010 005 865.3, filed Jan. 26, 2010, all of which are hereby incorporated by reference in their entirety.

### BACKGROUND

1. Technical Field

The invention relates to a process to manufacture a component that can be activated to emit light whereby the light emission is done by electroluminescence (EL).

2. Description of Related Art

First it should be explained that electroluminescence means the characteristic of certain materials or material combinations in which light is emitted in the visible range in response to an electrical alternating current. From practical applications, electroluminescent films are known in which the electroluminescent material is excited to light up by an electrical alternating field in a special condenser configuration. Such electroluminescent films are often also called luminescent films, light films, or condenser luminescent films. In technical applications they serve to convert electrical energy into light.

Furthermore, in practical applications there is the need for lighting or backlighting components with any surface/topography. Only by way of example, reference is made to instrument panel indicators in the front of a passenger car, operating knobs, pushbuttons and other elements such as information panels, etc.

The above-referenced electroluminescent films are excellent for use in components which need to be lit or backlit or made transparent provided these components have a simple geometry. The electroluminescent films are only of limited use in complicated structures, particularly in three-dimensional heavily structured surfaces. Only by way of example, reference is made to IMD technology (In Mould Decoration, cp. DE 197 17 740 C2), whereby films and, e.g., electroluminescent films are injected to the backside of the carrier to produce molds by injection molding technology. Heavily structured surfaces, particularly miniaturized components with electroluminescent surfaces, however, cannot be produced by applying this known process. In particular, the lighting of classic speedometer needles thus far was done by light-guiding systems whereby it is necessary to couple the light into the turning or rather oscillating/swiveling speedometer needle: This is technically cost-intensive. Still, this technology is mainly realized thus far.

### BRIEF SUMMARY

The purpose of the invention at hand is to specify a process to produce a component that can be activated to emit light by which the light is emitted through electroluminescence (EL). The process according to the invention shall allow covering nearly any structural surfaces and particularly very tiny or delicate components with electroluminescent layers, which allows lighting the surface of any functional elements, the interior of the material or the rear of the material/component.

According to the invention, initially a carrier is produced or provided, whereby the carrier has and includes essentially the form of the component and its mechanical and electrical interfaces. In this context, it is essential that the carrier is a type of blank for the component to be produced, namely a blank that does not yet possess the electroluminescent characteristic. Mechanical interfaces, e.g., in the form of an integral coupling element, can be an integral part of the carrier. Electrical interfaces can also be provided from the start or would be realized on the surface at an appropriate position during the production process.

In reference to the process according to the invention, it is of great significance that the carrier will be equipped with the functional layers of EL lighting, whereby at least one of the functional layers, namely the light-emitting layer or layers will be realized through the tampon printing process in whole or at least in part. The electrical interfaces—also in the area of the functional layers—are integrated into the print process so that the print technology process of the light-emitting layer/layers creates at the same time an electric contact. Subsequent contacting, which usually requires a significant constructive or process-technological time and effort, is unnecessary.

After the functional layers of the EL lighting are realized, a transparent or translucent cover is applied to the EL layers, which serves on the one hand as moisture protection and on the other hand as electrical and mechanical encapsulation. Therefore, with the application of the final cover, the component that can be activated to emit light, e.g., a speedometer needle is completed.

As specified above, at least the light-emitting layer is realized by way of tampon print. This is an indirect printing process which works according to the so-called gravure printing principle. The pad takes on the color according to the outside contour of the cavity of the printing plate and reproduces it during imprinting on a component with any surface. These can be restricted or sequential areas and they can have various shapes—also sequentially restricted.

While it has been recognized that the tampon printing process, which thus far has been normally used to apply print on plastic objects mostly in the advertising material industry, is particularly suitable to realize a light-emitting layer within the scope of EL lighting; in particular, because this process imprints the color also on three-dimensional surfaces or into deeper-lying areas. In addition, during the use of the tampon printing process it is of great importance that the color is transferred to the respective carrier at nearly 100% because of the technology underlying the tampon printing process. This already allows reducing the production costs significantly. It is also conceivable to print several layers whereby the result is lighter and darker light emissions.

The carrier may have nearly any topology on the surface. In general, the material may be rigid or flexible, e.g., in the form of an MID or metal-containing flexible plastics. The electroluminescent layer can be applied to structured surfaces using the tampon printing process, whereby the carrier can be equipped already beforehand with the electrical connections. Therefore, contacting and insulation between the various EL layers can be applied at the same time the EL layer is applied, whereby the insulating layers can be applied or generated in any way desired. In addition to the printing process, the contact surface can also be realized without any effort with the injection mold technology.

The electrical connections or the electrodes of the EL functional layers can be generated in various ways, e.g., by injection mold technology and/or print technology. In this context, it is conceivable to realize the electrical connections on and/or in the carrier. By overprinting or coating the connections, these can be coupled electrically or insulated depending on the used material. In addition, mask-like coatings or layers can be generated on the electrical connections/electrodes.

The light-emitting layer/layers is/are imprinted in the form of word and/or picture information as needed. The tampon printing process allows realization of structured surfaces along the surface profiles and strictly delineated areas with and without light-emitting layers. The variety of information which can be produced in this manner is limitless. In particular, the light-emitting layer may be formed on various levels, e.g., in a manner that any interruptions and repeat electrical connections are possible through direct imprinting of electrical connections. Everywhere where it is necessary, the insulating intermediate areas or intermediate layers can also be generated with printing or injection mold technology.

The functional layers are also imprinted by inserting insulators to generate the full function of the EL functional layers.

At this point, it should be mentioned that the process according to the invention uses the tampon printing process to generate at least the light-emitting layer/layers. In general, it is conceivable that additional functional layers, also light-emitting layers, can be generated with the tampon printing process as well as the injection mold process, lacquering technology, etc. The same applies to the insulators which are imperative for the construction of the EL functional layers. Furthermore it should be pointed out here that EL lighting, the use of EL functional layers defines any design of such functional layers to generate so-called EL lamps. It is not considered necessary to describe the precise design or the actual wiring because these are well-known from numerous reference works. Only as an example, additional reference should be made to DE 102 34 125 A1, whereby the EL functional layers are provided in form of an EL film.

The EL functional layers but at least the light-emitting layer encapsulating cover can be produced with the so-called 2K reaction process, whereby the CCM process (Clear Coat Moldering) is especially suitable. With this process, a sort of macro-encapsulating of the EL functional layers is possible, whereby the outer contour of the component can be covered or even a shape can be realized. The material used here can be transparent so that it can be lit through an underneath EL lamp generated by EL functional layers. In addition, it is conceivable to color the material of the cover or encapsulation. This allows generating a color filter in a perfect manner.

It is also conceivable to cover the EL functional layers with a translucent lacquer, whereby a so-called laser lacquer can be used. A laser is used to literally burn the laser lacquer so that any type of light geometries, and therefore the overall contour of the lighted area on the surface of the component, can be created.

The enclosure—however it can be generated—can be applied to the outline and/or reprocessed in relation to the surface. Finally, it is even possible to process the outer contour. This measure or these measures are also suitable to generate any type of surface structures, whereby in these cases the EL functional layers may lay underneath.

Furthermore, it should be noted that the carrier can comprise or include any number of electronic components; in particular, in highly miniaturized form. In addition it is conceivable to assign the carrier its own power source/a source of voltage, e.g., by using the solar voltaic layers to create practically a self-sustaining component. In particular, it is conceivable that any number of functional elements are or will be included in the carrier, e.g., through vacuum casting technology. There no limits in this case either.

### BRIEF DESCRIPTION OF THE FIGURES

Now, there are various options to develop and advance the teaching of the present invention in an advantageous manner. For this purpose, reference is made to the claims on the one side and the following explanation of preferred implementation examples of the invention based on the drawing. In connection with the explanation of the preferred implementation examples of the invention based on the drawing, the generally preferred arrangements and advancements of the teaching are explained. The drawing illustrates in

FIG. 1 a schematic view of the basic design of an implementation example of a component with the EL functional layers necessary for light emission in accordance with the invention, in

FIG. 2 a schematic view of the exemplary design of a component that includes a so-called EL lamp with mechanical and electrical interface, and in

FIG. 3 in a flowchart, schematically, possible process steps to produce a component that can be activated to emit light.

### DETAILED DESCRIPTION OF VARIOUS EMBODIMENTS

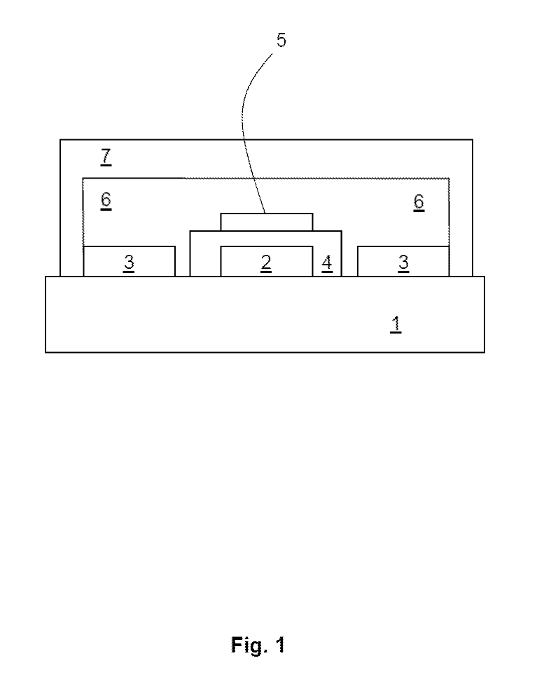

FIG. 1 shows an implementation example of a component produced according to the invention process, which includes an EL lamp to be activated to emit light.

The design shown in FIG. 1 demonstrates that the component includes initially a carrier 1. This can be any plastic substrate. The precise form is immaterial.

On carrier 1, a rear electrode 2 is applied. Furthermore, a ground wire 3 is provided. These are the electrical connections of the component.

The rear electrode 2 is covered by a dielectric 4. In addition, the dielectric 4 insulates the rear electrode 2 from the ground wire 3.

An electroluminescent layer 5 is applied with the tampon printing method to the dielectric 4. The electroluminescent layer 5 is covered by a conductive lacquer 6 which is at the same time the electric contact for the ground wire 3. All functional layers of the EL lighting can be imprinted.

Furthermore, the entire arrangement is covered by a sealing encapsulation 7, which has the effect of a macro-encapsulation namely for moisture protection and for electrical and mechanical encapsulation of the entire structure.

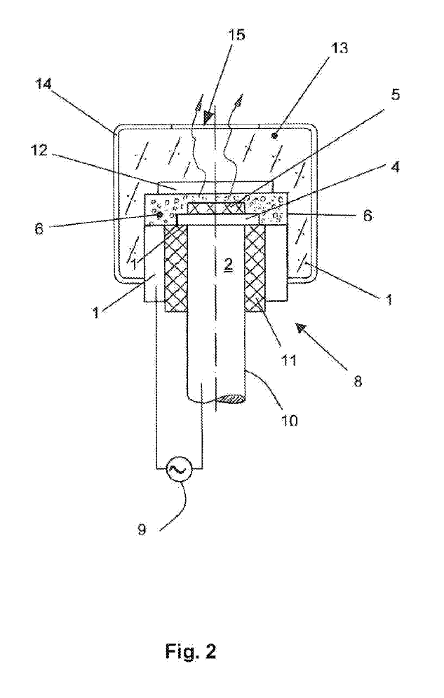

FIG. 2 shows in a schematic view another component, which is produced according to the invention, namely also with an integrated EL lamp.

The carrier 1 includes the electrical and mechanical coupling medium 8, whereby contacting is suggested by an AC voltage source 9. Between the carrier element 1 and an electrically conductive connection pin 10, an insulation 11 made of plastic is planned. Therefore, it is possible to connect the component shown in FIG. 2 both mechanically and electrically, namely due to the electrical/mechanical coupling medium 8 provided there.

The EL lamp of the component shown in FIG. 2 is similarly constructed as the EL lamp of the component shown in FIG. 1. The rear electrode 2 is formed by connecting pin 10. On top is the dielectric 4, which covers connecting pin 10 together with insulation 11. The EL layer 5 is applied to dielectric 4, which in turn is covered by the conductive lacquer 6.

A color coat 12 is applied to the conductive lacquer 6 in the implementation example selected in FIG. 2. It serves as color filter in reference to the light emission from EL layer 5.

The entire arrangement is CCM-overmolded, whereby the exterior shape of the component is more or less defined according to the specified original form. Transparent material is used for the CCM overmold 13.

Lacquer 14, which prevents light from shining through, is applied to the surface of the entire component. In turn lacquer 14 is recessed partially and with any type of structure/shape, namely with at least one viewing window 15 through which light can be emitted. The “lit” area and therefore the information to be provided can be defined as desired through the shape of viewing window 15.

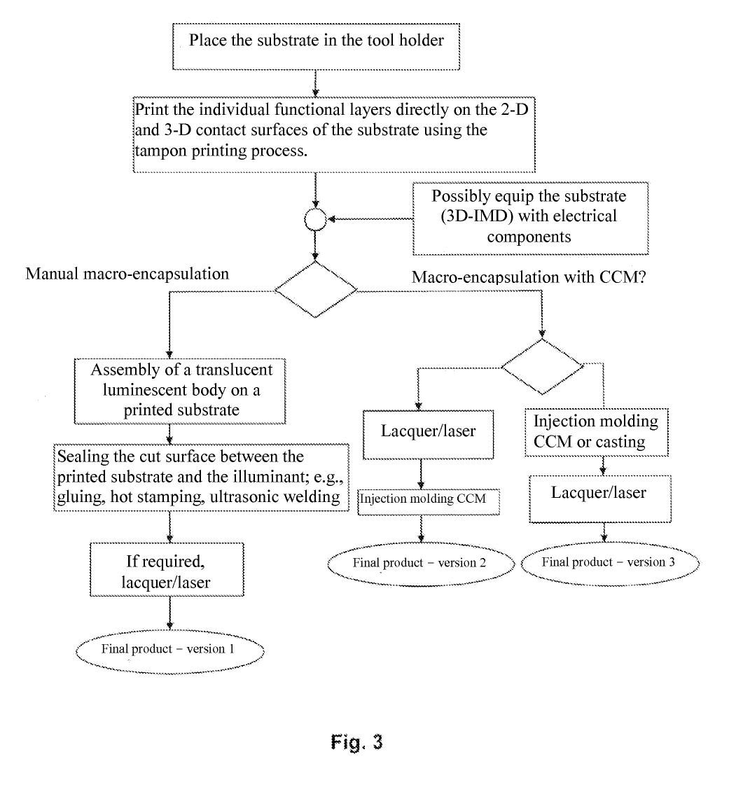

FIG. 3 shows in a process diagram the realization of the process according to the invention with alternative process steps. FIG. 3 is self-explanatory due to the description.

Therefore, it is, e.g., conceivable that the carrier is inserted into a tool holder, whereby the carrier can include the mechanical and electrical coupling medium.

In a next step, the individual functional layers are imprinted e.g., using the tampon printing process onto the two-dimensional or three-dimensional electrical contact surfaces of the carrier or the substrate. Afterwards or at the same time, it is possible to refine the carrier according to the already explained IMD technology, whereby it is conceivable that the carrier is equipped with electrical components.

After the EL lamp is realized, a macro-encapsulation is possible, which is pluggable, convertible or can be overmolded or cast, e.g., according to the CCM process. However, it is also conceivable to cover the entire arrangement with a prefabricated housing.

Subsequently, a translucent cover can be realized on the printed carrier or substrate. It is advantageous to seal the cut surface between the printed carrier/substrate and the encapsulation. Such a seal can be produced through gluing, hot stamping, ultrasonic welding, etc. Subsequently, the component can be lacquered or again imprinted or lasered.

As an alternative, the component with the EL layers is lacquered/lasered and subsequently insert-molded according to CCM or first insert-molded according to CCM and subsequently lacquered/lasered. The result is a component that is activated to emit light in accordance with the description to FIG. 1 and FIG. 2.

At this point, it should be noted that the process mentioned before illustrates the idea of the invention only schematically. Numerous additional process steps are conceivable; in particular to refine the process.

In reference to the teaching in accordance with the invention, it should be re-explained that any desired components, which include EL functional layers, can be produced according to the process of the invention. These can be any desired display and operating elements with integrated EL lighting. In particular, it is conceivable to realize miniaturized, movable components, which allow rotational and linear movements, according to the process of the invention.

The EL components in question here can have information/symbols of highest position precision, which is extremely difficult to realize when applying the IMD process. A simplified production can be realized with a minimum number of components.

In the process according to the invention, the shape of the EL component and in particular the desired light-emitting surface can be freely defined in form and size. There are almost no limitations in terms of electrical and optical or light-technological requirements.

The process according to the invention allows producing a simple, safe, and temperature change and corrosion-resistant contacting between electrical connection of a voltage source and the electrodes of the EL lamp.

The enclosing macro-encapsulation extends the lifespan of the component, e.g., by the application of transparent molding. In addition, the EL pigments in the light-emitting layer are preserved during the production process. An improved UV protection of the EL pigments can be realized by coloring the overmolding material or the molding material.

The EL component, which can be produced with the process according to the invention and which satisfies the specifications and standard decors of the automotive industry, is of special significance. A day and night design is easily created.

For example, the component which can be activated to emit light could be a speedometer needle, the structure of which is characterized by few parts. Such a speedometer needle could be especially a substitute for thus far known light guiding systems by printing the EL lamp directly onto the blank. Therefore, it allows a highly simplified structure and a rationalized, process-safe and cost-efficient production. In particular, such EL indicators are superior to standard components in their function.

To be precise, perfect illumination or lighting can be realized over the entire lit area and the entire length of the speedometer needle. The process according to the invention can also meet mechanical requirements; in particular in reference to a jerk-free movement of the speedometer needle. The weight distribution can be defined nearly freely.

Finally, it should be noted that the above-explained implementation examples serve only the exemplary explanation of the claimed teaching; however, this is not limited to these implementation examples.

### REFERENCE LIST

1 Carrier
2 Rear electrode
3 Ground wire
4 Dielectric
5 Electroluminescent layer (EL layer)
6 Conductive lacquer
7 Encapsulation
8 Electrical/mechanical coupling medium
9 AC voltage source
10 Connection pin
11 Insulation
12 Color coat
13 Overmolding
14 Lacquer
15 Viewing window

1-11. (canceled)

12. A method to manufacture a component that can be activated to emit light whereby the light emission is done by electroluminescence (EL), the method comprising the following steps:
providing and producing a carrier, the carrier comprising a component and its mechanical and electrical interfaces;
printing the carrier with one or more functional layers of EL lighting, whereby:
at least one of the one or more functional layers is generated with the tampon printing process; and
the electrical interfaces are integrated into the print; and
generating at least one of a transparent an translucent cover as protection from moisture and for electrical and mechanical encapsulation.

13. The method according to claim 12, wherein the at least one of the one or more functional layers is at least one light-emitting layer.

14. The method according to claim 13, wherein only a portion of the at least one light-emitting layer is generated with the tampon printing process.

15. The method according to claim 12, wherein the carrier contains an area serving as a mechanical interface, wherein the area is at least equipped with parts of the electrical interface.

16. The method according to claim 12, wherein the carrier comprises rigid conductor paths.

17. The method according to claim 12, wherein the carrier comprises flexible conductor paths.

18. The method according to claim 12, wherein at least one of the electrical interfaces are realized and imprinted by way of at least one of injection molding technology and printing technology.

19. The method according to claim 13, wherein the light-emitting layer is printed in the form of at least one of word and picture information.

20. The method according to claim 13, wherein the light-emitting layer is designed zonal.

21. The method according to claim 20, wherein the light-emitting layer is designed on various levels.

22. The method according to claim 12, wherein the one or more functional layers can be imprinted under interconnection of one or more insulators.

23. The method according to claim 22, wherein the one or more insulators are generated by at least one of injection molding technology, lacquer technology, and printing technology.

24. The method according to claim 12, wherein the cover is applied via a 2K reaction process.

25. The method according to claim 24, wherein the cover is applied via a Clear Coat Moldering (CCM) process.

26. The method according to claim 12, wherein the cover is applied to the contour.

27. The method according to claim 12, wherein the cover is reprocessed in relation to the surface.

28. The method according to claim 12, wherein the cover is applied to the contour and is reprocessed in relation to the surface.

29. The method according to claim 12, wherein the carrier comprises at least one electronic components.

30. The method according to claim 12, wherein the carrier comprises at least one power/voltage source.
